(19) United States
(12) Patent Application Publication
(10) Pub. No.: US 2007/0047229 A1
(43) Pub. Date: Mar. 1, 2007

(54) LED module and line type LED illumination lamp using the same

(76) Inventor: Sang Woo Lee, Seoul (KR)

Correspondence Address: CANTOR COLBURN, LLP, 55 GRIFFIN ROAD SOUTH, BLOOMFIELD, CT, 06002, US

(21) Appl. No.: 11/511,797

(22) Filed: Aug. 29, 2006

(30) Foreign Application Priority Data
Aug. 30, 2005 (KR) 10-2005-0079930

(51) Int. Cl. F21V 5/00

(52) U.S. Cl. 362/237; 362/240; 362/246; 362/249

(57) ABSTRACT

Provided are an LED module and a line type LED illumination lamp. The LED (light emitting diode) module including a plurality of LEDs emitting light of predetermined colors, includes: a substrate formed in the form of line that is long in length and relatively narrow in width, and including a first substrate and a second substrate electrically connected to each other and on which a plurality of LED bases for installation for the individual LEDs are formed; LED installation members attached to the LED bases and to which the LEDs are attached, respectively; and lenses respectively fixed to the LED installation members, the lenses manipulating the colors of the light emitted from the LEDs while transmitting the light.

### BACKGROUND OF THE INVENTION

1. Field of the Invention

The present invention relates to a light emitting diode (LED) module and a line type LED illumination lamp using the same, which irradiates manipulated light onto various objects such as bridges or buildings to give decorative effects thereto, and more particularly, to an LED module and a line type LED illumination lamp, which can maintain sufficient durability, can maintain stability of the illumination lamp by effectively releasing heat generated from the LED module, and can irradiate light of various colors from the LED.

2. Description of the Related Art

In general, various types of illumination lamps are being used to provide light at night or to a room or to light an object. Such an illumination lamp converts electrical energy to optical energy upon receiving power, and thus provides light or illuminates an object. An incandescent lamp or a fluorescent lamp is commonly used as the illumination lamp.

In recent years, an illumination lamp using a light emitting diode (LED) is being widely used despite its high price because light of various colors can be irradiated therefrom. However, such an LED illumination lamp has the following problems. The efficiency of the LED illumination lamp is lowered by heat generated when it is used for a certain period of time, and further, a lifespan thereof is shortened by an increase in heat generation due to a long time use.

As one example of the illumination lamps, an LED sight illumination lamp is disclosed in Patent Registration No. 0502056. FIGS. 1 and 2 are views illustrating the LED sight illumination lamp. In FIGS. 1 and 2, a sight illuminating lamp system includes an illumination lamp frame 1 having therein an LED, frame side caps 2 mounted to right and left sides of the illumination lamp frame 1, and a frame support 3 mounted under the illuminating lamp frame 1 and supporting the illumination lamp frame 1. The illumination lamp frame 1 includes therein a transparent lens part 4 mounted at an upper end portion and formed of polycarbonate, an LED module 5 mounted at a middle portion and including an LED 5a, a lens cover 5b, and a lens 5c, and a illumination control unit 6 mounted at a lower end portion and provided with a constant-current switching driver to control the LED.

According to the aforementioned structure, the LED sight illumination lamp of Patent Registration No. 0502056 has a good heat-release property because the illumination lamp is not bent. The direction of the LED sight illumination lamp can be easily controlled, and the attachment and detachment of the illumination lamp frame are facilitated.

However, the LED sight illumination lamp of Patent Registration No. 0502056 has the following problems. Because the frame has a very small thickness for the heat release effect, the durability of the entire frame is lowered, and thus it is easily deformed or broken down by external impact. Due to the lowered durability, the entire length of the frame cannot be extended to more than a predetermined extent, which complicates installation and connection operations.

### SUMMARY OF THE INVENTION

Accordingly, the present invention is directed to an LED module and a line type LED illumination lamp using the same that substantially obviates one or more problems due to limitations and disadvantages of the related art.

An object of the present invention is to provide an LED module, which can prevent breakdown or inoperability caused by overheating by means of effectively dissipating or releasing heat generated when an LED emits light, and can irradiate light of various colors for decorative effects by being installed in various locations in various forms.

Another object of the present invention is to provide a line type LED illumination lamp, which can allow extension of a length thereof and sufficiently maintains heat release performance by maintaining sufficient durability, and can provide light of various colors for decorative effects.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an LED (light emitting diode) module including a plurality of LEDs emitting light of predetermined colors, including: a substrate formed in the form of line that is long in length and relatively narrow in width, and including a first substrate and a second substrate electrically connected to each other and on which a plurality of LED bases for installation for the individual LEDs are formed; LED installation members attached to the LED bases and to which the LEDs are attached, respectively; and lenses respectively fixed to the LED installation members, the lenses manipulating the colors of the light emitted from the LEDs while transmitting the light.

In another aspect of the present invention, there is provided a line type LED illumination lamp including: a frame installed at or around an object to be illuminated and dissipating heat outwardly; an LED module installed in the frame; a light transmissive lens transmitting light emitted from the LED module toward an object to be illuminated; and covers respectively coupled to both sides of the frame and shielding the inside of the frame, wherein the LED module comprises:

a plurality of LEDs emitting light of predetermined colors; a substrate shaped into a line form having a long length and a relatively short width, the substrate including a first substrate and a second substrate electrically connected to each other and on which a plurality of LED bases is formed to receive the individual LEDs; LED installation members attached to the LED bases and to which the LEDs are attached, respectively; and lenses respectively fixed to the LED installation members, the lenses manipulating the colors of the light emitted from the LEDs while transmitting the light.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exploded perspective view of an LED sight illumination lamp of Patent Registration No. 0502056;

FIG. 2 is an assembled cross-sectional view of the LED sight illumination lamp of FIG. 1;

FIG. 3 is an exploded perspective view of a line type LED illumination lamp according to the present invention;

FIG. 4A is an enlarged cross-sectional view of a main body of FIG. 3, FIG. 4B is a partial enlarged cross-sectional view of a heat release hole of a substrate of the LED module of FIG. 3, FIG. 4C is an enlarged cross-sectional view of a support portion of the LED module of FIG. 3, FIG. 4D is an enlarged cross-sectional view of a lens of the LED module of FIG. 3, and FIG. 4E is an enlarged perspective view of a cap of FIG. 3;

FIG. 5 is an assembled perspective view of the line type LED illumination lamp of FIG. 3;

FIG. 6 is an enlarged cross-sectional view taken along line VI-VI of FIG. 5; and

FIG. 7 is an enlarged cross-sectional view illustrating releasing of heat in the line type LED illumination lamp according to the present invention.

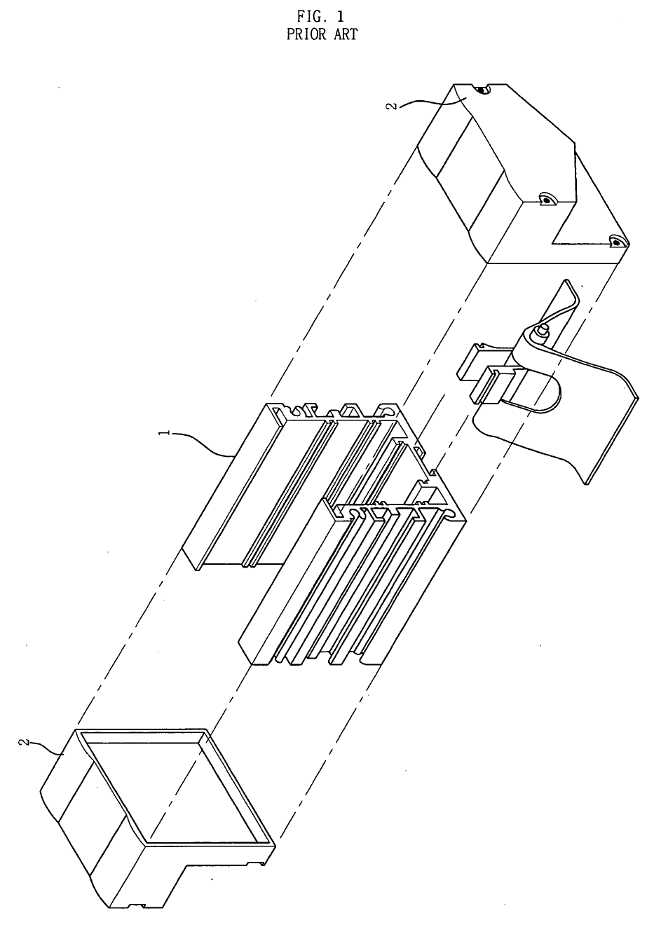

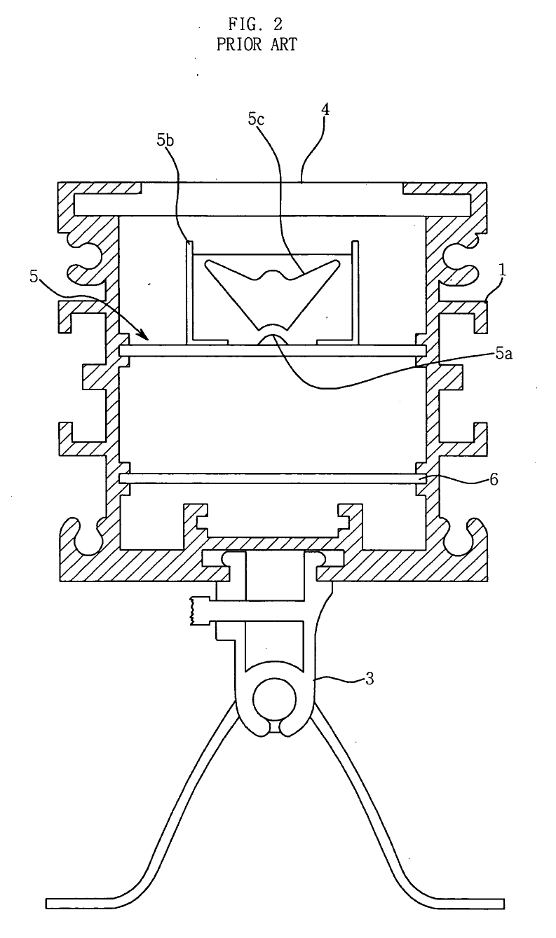

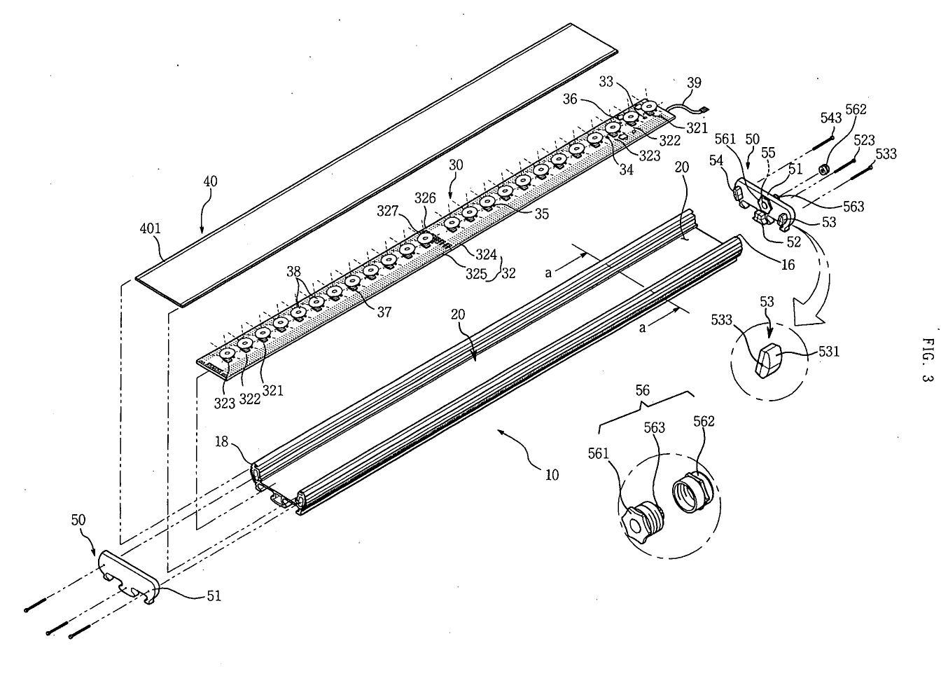

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

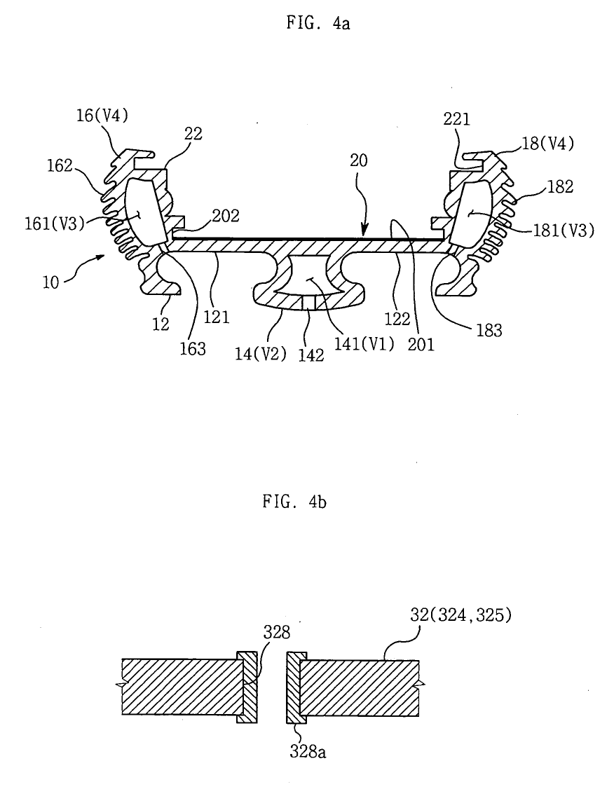

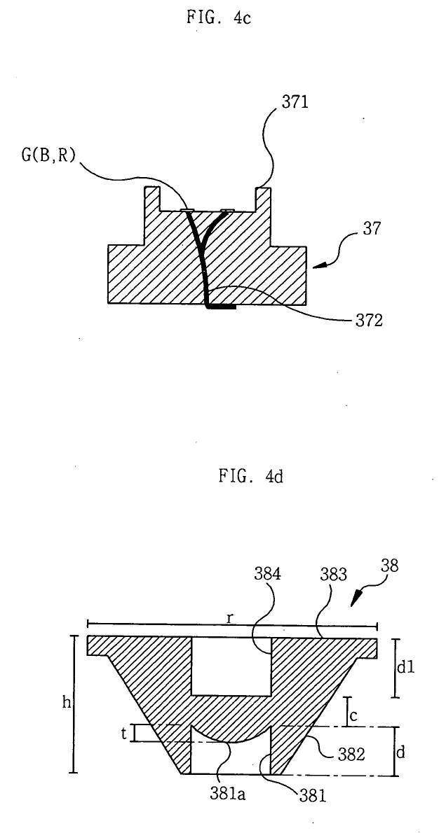

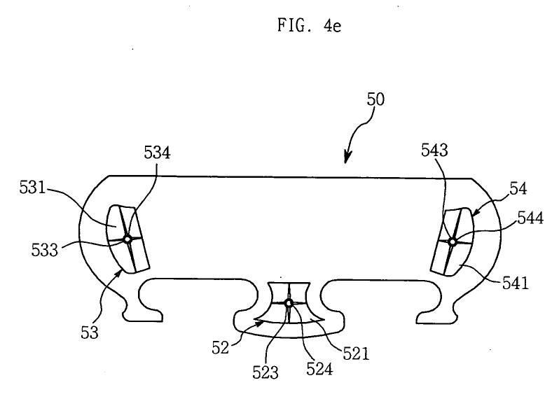

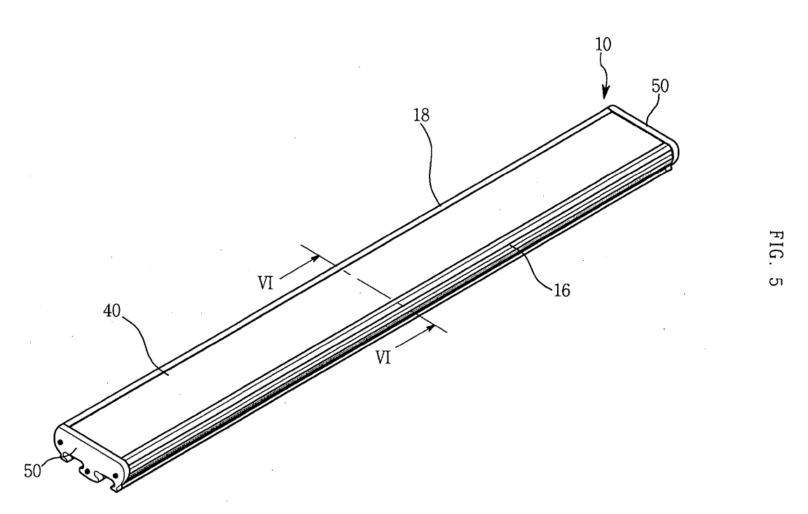

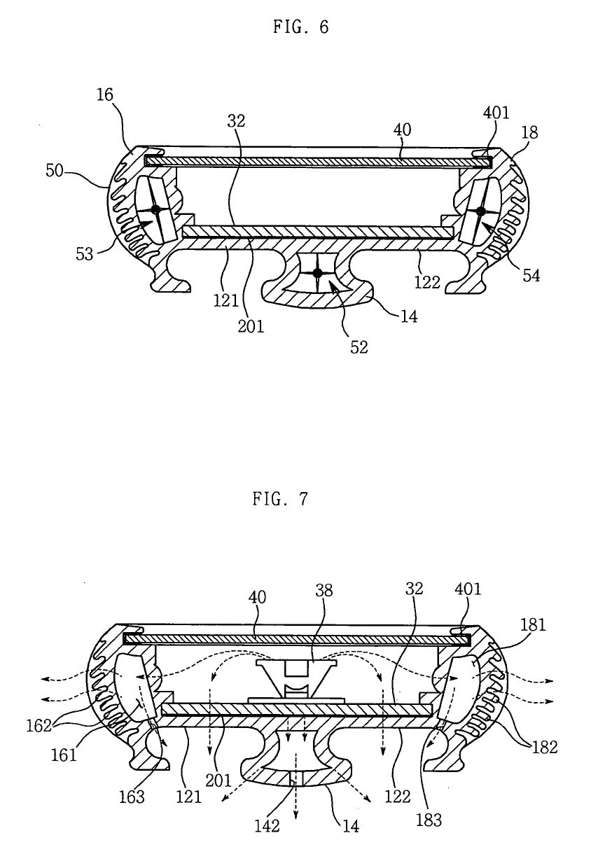

FIG. 3 is an exploded perspective view of a line type LED illumination lamp according to the present invention. FIG. 4A is an enlarged cross-sectional view of a main body of FIG. 3, FIG. 4B is a partial enlarged view of a heat release hole of a substrate of the LED module of FIG. 3, FIG. 4C is an enlarged cross-sectional view of a support of the LED module of FIG. 3, FIG. 4D is an enlarged cross-sectional view of a lens of the LED module of FIG. 3, and FIG. 4E is an enlarged perspective view of a cap of FIG. 3. FIG. 5 is an assembled perspective view of the line type LED illumination lamp of FIG. 3, and FIG. 6 is an enlarged cross-sectional view taken along line VI-VI of FIG. 5. FIG. 7 is an enlarged cross-sectional view of a state of heat release of a line type LED illumination lamp according to the present invention.

In FIGS. 3 to 7, a reference numeral 10 is a frame fixed to a wall or a bar by a fixing unit or a mounting unit such as a bracket. The frame 10 is lightweight, and is formed by extruding aluminum having an excellent heat release property.

A mounting part 12 is formed at the rear of on a rear surface of the frame 10 for installation of the fixing unit or the mounting unit fixed to a fixed object such as a wall or a bar. The mounting part 12 includes two mounting grooves 121 and 122 formed parallel at upper and lower portions of the frame 10 over the entire length of the frame 10.

A support 14 is extendingly formed between the mounting grooves 121 and 122 of the mounting part 12 over the entire length of the frame, and supports firm insertion and maintenance of the fixing unit or the mounting unit (not shown) A heat collecting space 141 is formed in the support 14 over the entire length thereof to collect heat generated from an LED module to be described later. Exhaust holes 142 are formed on the support 14 at regular intervals to release heat collected in the heat collecting space 141 to the outside.

The support 14 should be formed to ensure a sufficient volume of the heat collecting space 141 therein so that a sufficient amount of heat can be effectively collected and released, while the strength and durability of the support 14 itself are maintained to a sufficient extent at the time of mounting of the mounting unit (not shown). In order to meet such conditions, the volume (V1) of the collecting space 141 should be ⅓ to ½ of the entire volume (V2) of the support 14 including its exterior. When the volume (V1) of the collecting space 141 becomes smaller than ⅓ of the entire volume (V2) of the support 14, the durability becomes excellent while the heat release property is degraded. In contrast, when the volume (V1) of the collecting space 14 becomes greater than ½ of the entire volume (V2) of the support 14, the heat release property becomes excellent while the durability is degraded, which increases possibilities of cracks or damage.

Heat release parts 16 and 18 are symmetrically formed at upper and lower portions of the mounting part 12 of the frame 10. The heat release parts 16 and 18 respectively have heat collecting spaces 161, 181 that are formed over the entire length of the frame 10, and collect heat generated from an LED module to be described later. A plurality of heat release fins 162, 182 is protrudingly formed on an outer side of each of the heat release parts 16 and 18 at regular intervals to release heat collected in each of the heat collecting space 161 and 181.

The heat release parts 16 and 18 may include heat release holes 163 and 183 communicating with the mounting grooves 121 and 122 in order to more effectively release heat in the heat collecting spaces 161 and 181, respectively.

Similarly to the support 14, the heat release parts 16 and 18 should be formed to ensure sufficient spaces for the collecting spaces 161 and 181 so that a sufficient amount of heat can be collected and released, while maintaining sufficient durability against external impact that may be applied. To meet such conditions, the volume (V3) of each of heat collecting spaces 161 and 181 of the heat release parts 16 and 18 should be ½ to ⅔ of the volume (V4) of an entire exterior of each of the heat release parts 16 and 18. When the volume (V3) of each heat collecting space 161, 181 becomes smaller than ½ of the entire volume (V4) of each heat release part 16, 18, the durability becomes excellent while the heat collection property and the heat release property are lowered. In contrast, when the volume (V3) becomes greater than ⅔ of the volume (V4), the heat release property becomes excellent and the durability is lowered, which makes the heat release part vulnerable to the external impact.

A fixing part 20 which an LED module to be described later is inserted in and installed at is formed at a lower portion inside the frame 10. A surface of the fixing part 20 is flat, and particularly, is coated with a heat transfer layer 201 for effectively transferring or releasing heat generated from an LED module toward the support 14. The heat transfer layer 201 is formed of a thermal compound. Fixing grooves 202 facing each other are formed at the upper and lower portions of the frame 10 over the entire length thereof, and both sides of an LED module to be described later are inserted in and fixed to the fixing grooves 202.

Support parts 22 facing each other are formed along both sides of an upper portion of the inside of the frame 10 over the entire length thereof, and allow stable fixation of a lens to be described later. Support grooves 221 are formed at both support parts 22, so that both sides of a lens to be described later can be inserted in and fixed to the support grooves 221.

A reference numeral 30 is an LED module installed on the fixing part 20 formed inside the frame 10. The LED module 30 is formed in a line type, and is manufactured and assembled with a length corresponding to that of the frame 10.

The LED module 30 includes a substrate 32 that is long in length and narrow in width. Green, blue and read (G, B and R) LED bases 321, 322 and 323 are disposed successively on the substrate 32 in the order of G, B and R.

The substrate 32 is formed of two connected substrates for the purpose of facilitation of a manufacturing process and utility of a manufacturing space. That is, the substrate 32 includes a first substrate 324 and a second substrate 325 connected to the first substrate 324. The LED bases 321, 322 and 323 are disposed successively on both the first and second substrates 324 and 325 with their arrangement order maintained.

A resistance 33 is installed on each of the first and second substrates 324 and 325 in order to maintain stable current supply to each LED to be described later by preventing excessive supply thereof only some of resistances 33 are illustrated in the drawing for the clarity of the description. Also, a condenser 34 accumulating a current is installed on the first substrate 324 only some of condensers 33 are illustrated in the drawing for the clarity of the description.

A diode 35 is installed on each of the first and second substrates 324 and 325 to control a direction of currents flowing toward each of the LED bases 321, 322 and 323.

An integration circuit 36 for overall control of a current being supplied to each of the LED bases 321, 322 and 323 is installed at one side of the first substrate 324.

LED installation members 37 are attached to the LED bases 321, 322 and 323 of the substrates 324 and 325, respectively. Circular support portions 371 are formed at the LED installation members 37, respectively. Also, a semiconductor or a conductor 372 is installed in each LED installation member 37 and is exposed to a surface of the corresponding support portion 371, so that it can be electrically connected to the LED base 321, 322 or 323. A corresponding LED is installed at each support portion 371. That is, a green LED (G) is connected and attached to the conductor 372 of the support portion 371 of the installation member 37 attached to the green LED base 321, and a blue LED (B) is connected and attached to the conductor 372 of the support portion 371 of the installation member 37 attached to the blue LED base 322. A red LED (R) is connected and attached to the conductor 372 of the support part 371 of the installation member 37 attached to the red LED base 323. Of course, the proper wattage is determined based on the wattage of an illumination lamp to which such LEDs (G, B and R) are to be applied, and then, the number of LEDs (G, B and R) is determined corresponding to the determined wattage.

Lenses 38 transmitting light emitted from the LEDs (G, B and R) are installed on the support parts 371 of the LED installation members 37, respectively. Each lens is formed as a reverse-cone shape or a speaker shape for the effective light transmission. The lens is provided with a cylindrical fixing portion 381 detachably inserted over the support portion 371 of the installation member 37. The fixing portion 381 has at its upper part a backward convex portion 381a that is curved backward or downward in order to increase efficiency of radial light emission. The fixing portion 381 has an outer portion 382 having a reverse cone shape a diameter of which gradually increases upwardly from its lower end. A disc-shaped first light irradiating portion 383 is formed integrally on the outer part 382. A second light irradiating portion 384 is integrally formed at a center part of the first light irradiating portion 383, extending toward the fixing portion 381 in a vertical downward direction. The second light irradiating portion is spaced apart from the fixing portion 381 at a predetermined interval, and allows light to be irradiated to the center.

A size of every portion that makes the lens 38 achieve the maximum light emitting efficiency will now be described. On the assumption that the entire height of the lens 38 is h, a depth (d) of the fixing part 381 is set to h/3, and a thickness (t) of the backward convex portion 381a is set to h/6, and an outer diameter (R) of the first light emitting part 383 is set to 2h. A depth (d1) of the second light emitting part 384 is set to 8h/15, and a gap (C) and a step difference between an upper end of the fixing part 381 and a lower end of the second light emitting part 384 is set to 2h/15.

Heat release holes 324 are formed on the first and second substrates 324 and 325 forming the substrate 32 to dissipate, circulate or release heat generated when the LEDs (G, R and B) emit light. Each heat release hole 328 is formed as a very small circular shape, and is coated with a thin film 328a having excellent heat transmission and heat release rates in order to improve heat release performance. The thin film 328 is formed of nickel or copper by a deposition process.

An electric wire 39 is connected to the first substrate 324. The electric wire 38 is connected to a controller (not shown) in order to supply power to each LED (G, R and B) and control ON/OFF of each LED (G, R and B).

A reference numeral 40 denotes a light transmissive lens fixed to the support part 22 of the frame 10, transmitting light emitted from the LED module 30, and shielding the LED module 30 from the outside. The light transmissive lens 40 is formed of a transparent polycarbonate that can maintain a light transmittance property while maintaining its own strength.

Seal members 401 are provided to both sides of the light transmissive lens 40 inserted in the support grooves 221 of the support part 22, and thus prevent raindrops or foreign substances from entering thereinto through a gap between the lens 40 and the support groove 221 of the support part 22. The seal member 401 is formed of silicon or urethane.

A reference numeral 50 is a cap for hermetical sealing by shielding both sides of the frame 10. Caps 50 are formed in shapes corresponding to shapes or cross-sections of both side end of the frame 10.

Each cap 50 has a body 51 formed corresponding to a shape of each side end of the frame. A first coupling member 52, a second coupling member 53, and a third coupling member 54 for fixing the body 51 to the frame 10 protrude integrally from an inner side of the body 51. The first coupling member 52 has a shape corresponding to the heat collecting space 141 of the support 14 so as to be pressingly inserted in the heat collecting space 141. The second coupling member 53 has a shape corresponding to the heat collecting space 161 of the heat release part 16 so as to be pressingly inserted and fixed to the heat collecting space 161. The third coupling member 54 has a shape corresponding to the heat collecting space 181 of the heat release part 18 so as to be pressingly inserted and fixed to the heat collecting space 181 of the heat release part 18.

The coupling members 52, 53 and 54 are divided into two to four diverging pieces 521, 531 and 541 to coupled and fixed more firmly and stably to the corresponding heat collecting spaces 141, 161 and 181, respectively. Axial holes 523, 533 and 543 are formed at central axes of the coupling members 52, 53 and 54, and coupling bolts 524, 534 and 544 are coupled to the axial holes 523, 533 and 543, respectively.

According to the aforementioned structure of the coupling members 52, 53 and 54, after the coupling members 52, 53 and 54 are inserted in the sides of the corresponding heat collecting spaces 141, 161, 181, the coupling bolts 524, 534 and 544 are fastened through the axial holes 523, 533 and 543, respectively. Then, the diverging pieces 521, 531 and 541 of the coupling member 52, 53 and 54 are expanded out or spread out and thus are pressingly attached to inner surfaces of the heat collecting spaces 141, 161 and 181, respectively. Accordingly, firm and stable coupling can be achieved.

Of course, at least one of the caps 50 coupled to the frame 10 has a through hole 55 through which the electric wire 39 connected to the LED module 30 extends out. An adaptor 56 which the wire 39 penetrates through and is fixed to is installed at the through hole 55.

The adaptor 56 includes a bolt 561 fixed to the through hole 55 and in which the electric wire 39 is inserted, and a nut 562 screw-coupled to the bolt 56 and stably fixing the electric wire 39. Particularly, the bolt 561 is provided with a packing 563 that provides liquid-tightness or airtightness as the bolt 561 is closely attached to the electric wire 39 by fastening the nut 562.

An operation mode and effects of the line type LED illumination lamp having the aforementioned structure according to the present invention will now be described.

To assemble the line type LED illumination lamp, a thermal compound is applied onto a surface of the fixing part 20 of the frame 10 to form a heat transfer layer 201. Then, the LED module 30 is inserted in the fixing grooves 202 formed at both sides of the fixing part 20.

Next, an operator locates sealing members 401 to both sides of the light transmissive lens 40 in a state where the LED module 30 is stably fixed. Then, both sides of the light transmissive lens 40 are inserted in the support grooves 221 of the support part 22 of the frame 10.

Finally, the caps 50 are coupled to both sides of the frame 10. The cap 50 is coupled to the frame in a state where the electric wire 39 has been inserted in the bolt 561 of the adaptor 56 provided at the body 52 of the cap 50. In this state, the coupling bolts 524,534 and 544 are inserted and fastened into the axial holes 523, 533 and 543 of the coupling members 52, 53 and 54 inserted in the heat collecting spaces 141, 161 and 181 of the frame 10, respectively. Then, the diverging pieces 521, 531 and 541 of the coupling members 52, 53 and 54 are expanded out to be pressingly attached to inner surfaces of the collecting spaces 141, 161 and 181, respectively. In such a manner, the caps 50 are firmly coupled to both sides of the frame 10, thereby completing the line type LED illumination lamp.

The line type LED illumination lamp completed in the aforementioned manner is provided with a mounting unit such as the support (not shown) at the mounting part 12 of the frame 10. Therefore, the line type LED illumination lamp can be installed at a predetermined location such as a ground, a bridge, a building or the like, to irradiate light onto a corresponding object.

After installation of the lamp, when power and control commands are transmitted to the LED module 30 through the electric wire 39 connected thereto by turning ON a controller (not shown), the LEDs (R, G and B) emit light of their own colors, red, green and blue. Then, the emitted light of various colors undergoes changes in refraction angle and incidence angle by the backward convex portion 381a, the outer portion 382 of a reverse cone shape, the first light irradiating portion 383 of a disc shape, and the second light irradiating portion 384 of a cylindrical shape. Thus, such changes, and the successive disposition of the LEDs (G, B and R) allow light of various colors to be irradiated for decorative effects.

Particularly, a portion of heat generated from the LED module 30 is released by the heat release parts 16 and 18 placed at upper and lower sides of the frame 10 on the drawing. That is, a portion of the heat generated from the LED module 30 is collected in the heat collecting spaces 161 and 181 of the heat release parts 16 and 18, and then is released to the outside through a plurality of outer heat release fins 162 and 182. Also, a portion of the heat is released through the heat release holes 163 and 183 communicating with the mounting grooves 121 and 122 of the mounting part 12. The heat release performance is improved because the heat collecting spaces 161 and 181 of the heat release parts have sufficient volumes.

The remaining portion of the heat generated from the LED module 30 is transferred to the heat transfer layer 201 applied on the surface of the fixing part 20 of the frame 10 through the first and second substrates 324 and 325 and the heat release holes 328 formed on the substrates 324 and 325. The portion of the heat is released to the outside through the mounting grooves 121 and 122 of the mounting part 12, and the other portion of the heat is transferred to the heat collecting space 141 of the support 14 and then released to the outside, or is released to the outside through the exhaust hole 142.

Accordingly, the frame 10 can maintain sufficient strength, which allows manufacturing and installing of a long illumination lamp and allows release of a sufficient amount of heat generated. Also, the unique structure of the lens may implement light of various manipulated colors for decorative effects.

As described so far, the line type LED illumination lamp according to the present invention has the following effects. Because the sufficient strength of the frame is maintained, the illumination lamp can be manufactured and installed with its length selectively set. The line type LED illumination lamp has an excellent heat release property because of a sufficient heat release space and an expansion of an area, thereby maintaining stable operation. A unique lens structure of the line type LED illumination lamp can provide light of various colors by manipulating colors of the light emitted from the LED.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An LED (light emitting diode) module including a plurality of LEDs emitting light of predetermined colors, comprising:
a substrate formed in the form of line that is long in length and relatively narrow in width, and including a first substrate and a second substrate electrically connected to each other and on which a plurality of LED bases is formed to receive the individual LEDs;
LED installation members attached to the LED bases and to which the LEDs are attached, respectively; and
lenses respectively fixed to the LED installation members, the lenses manipulating the colors of the light emitted from the LEDs while transmitting the light.

2. The LED module according to claim 1, wherein the first substrate and the second substrate include heat release holes for dissipating, circulating or releasing heat generated when the individual LEDs emit light, the heat release holes being coated with heat transmissive thin films.

3. A line type LED illumination lamp comprising:
a frame installed at or around an object to be illuminated and dissipating heat outwardly;
an LED module installed in the frame;
a light transmissive lens transmitting light emitted from the LED module toward an object to be illuminated; and
covers respectively coupled to both sides of the frame and shielding the inside of the frame,
wherein the LED module comprises:
a plurality of LEDs emitting light of predetermined colors;
a substrate shaped into a line form having a long length and a relatively short width, the substrate including a first substrate and a second substrate electrically connected to each other and on which a plurality of LED bases is formed to receive the individual LEDs;
LED installation members attached to the LED bases and to which the LEDs are attached, respectively; and
lenses respectively fixed to the LED installation members, the lenses manipulating the colors of the light emitted from the LEDs while transmitting the light.

4. The illumination lamp according to claim 3, wherein the frame is formed by extruding aluminum, and includes a mounting part at a rear surface thereof, heat release parts at upper and lower portions of the frame, and a fixing part therein,
wherein the mounting part includes two mounting grooves formed parallel along a longitudinal direction of the frame, a support formed between the mounting grooves, and a heat collecting space collecting a portion of heat generated from the LED module,
the heat release parts include heat collecting spaces collecting a portion of heat generated from the LED module, a plurality of heat release fins protrudingly formed at regular intervals and releasing heat collected in the heat collecting spaces to the outside, and heat release holes, respectively; and
the fixing part includes a heat transfer layer transferring heat generated from the LED module to the mounting part, and fixing grooves which both sides of the LED module are inserted in and fixed to.

5. The illumination lamp according to claim 4, wherein a volume of the heat collecting space of the support is set to ⅓ to ½ of the entire volume of the support, and a volume of the heat collecting space of each heat release part is set to ½ to ⅔ of the entire volume of an exterior of the heat release part.

6. The illumination lamp according to claim 3, wherein each of the covers includes:
a body having a shape corresponding to that of each side end of the frame;
a first coupling member integrally formed at an inner side of the body, and having a shape corresponding to that of the heat collecting space of the support of the frame to be pressingly inserted in and fixed to the heat collecting space of the support;
a second coupling member having a shape corresponding to that of the heat collecting space of one of the heat release parts of the frame so as to be fixedly inserted into the heat collecting space of the one of the heat release parts by pressure; and
a third coupling member having a shape corresponding to that of the heat collecting space of the other of the heat release parts of the frame so as to be fixedly inserted into the heat collecting space of the other of the heat release parts by pressure.

7. The illumination lamp according to claim 6, wherein each coupling member of the cover is divided into two to four diverging pieces, and has at its axis an axial hole in which a coupling bolt is inserted, the coupling bolt expanding out the diverging pieces.

8. The illumination lamp according to claim 3, wherein each lens of the LED module integrally comprises:
a fixing portion detachably inserted over a support portion of the installation member and having a backward convex portion curved backward;
an outer portion having a reverse cone shape with a diameter gradually increasing upwardly from a lower end;
a first light irradiating portion formed on the outer portion; and
a second light irradiating portion extending from a central portion of the first light irradiating portion in a vertical downward direction, spaced apart from the fixing part at a predetermined interval therebetween, and transmitting light to the center.

9. The illumination lamp according to claim 8, wherein, on the assumption that the entire height of the lens is ‘h’, a depth of the fixing portion is set to h/3, a thickness of the backward convex portion is set to h/6, an outer diameter of the first light irradiating portion is set to 2h, a depth of the second light irradiating portion is set to 8h/15, and a gap or a step difference between an upper end of the fixing portion and a lower end of the second light irradiating portion is set to 2h/15.
